(19) United States
(12) Patent Application Publication
(10) Pub. No.: US 2010/0177594 A1
(43) Pub. Date: Jul. 15, 2010

(54) ATTENUATION OF UNWANTED ACOUSTIC SIGNALS BY SEMBLANCE CRITERION MODIFICATION

(75) Inventors: Sandip Bose, Brookline, MA (US); Alain Dumont, Kawasaki-shi (JP); Henri Pierre Valero, Belmont, MA (US)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: Schlumberger Technology Corporation, Cambridge, MA (US)

(21) Appl. No.: 12/352,848

(22) Filed: Jan. 13, 2009

(51) Int. Cl. G01V 1/28

(52) U.S. Cl. 367/26

(57) ABSTRACT

Methods and related systems are described for modified semblance criterions based on the approach of thresholding the signal energy. A first criterion is derived by posing the problem as that of detecting a signal with energy (or amplitude) greater than the specified threshold and deriving the generalized likelihood ratio test statistic. A second criterion is derived using the same method by posing the problem as that of rejecting any signal with energy (or amplitude) below a specified threshold and detecting it if its energy is above another threshold greater than or equal to the first. These appropriately modify the original semblance criterion which is shown to be equivalent to the GLRT test statistic in the absence of any threshold on the signal amplitude. In addition simpler modifications are also described. Tests on synthetic data illustrate the effectiveness of all these modifications which perform comparably well at suppressing unwanted arrivals while accurately processing the desired signals.

### BACKGROUND OF THE INVENTION

1. Field of the Invention

This patent specification relates acoustic measurements made in a borehole. More particularly, this patent specification relates to methods and systems for reducing unwanted signals from acoustic data gathered from boreholes.

2. Background of the Invention

The semblance criterion is the basis for a widely used method for estimating sonic slowness especially with P&S logging. For example, see C. V. Kimbal and T. Marzetta Semblance Processing of borehole acoustic array data. Geophysics, 49(3):264-281, March 1984 (hereinafter “Kimball 1984”) which is incorporated by reference herein. With P&S logging, i.e., monopole logging for compressional and shear using the head waves, an array-based non-dispersive processing is used which is suitable for detecting signals irrespective of their energy. This property is invaluable for detecting compressional arrivals which are usually weak relative to other arrivals and accurately extracting their slowness and for this reason it has been extremely successful and widely used.

However a side effect of the same property of invariance to signal amplitude is that it also responds to very weak events such as weak tool or casing arrivals or even acquisition artifacts. While such unwanted semblance peaks if they exist can be handled by a variety of methods, these become a more serious issue for LWD applications where the processing has to be conducted downhole. Even when the sonic hardware is designed to attenuate the tool arrivals and further mitigation is possible with advanced processing techniques, there may still exist a need to avoid such spurious semblance peaks on tool arrivals.

### SUMMARY OF THE INVENTION

According to embodiments, a method of processing borehole sonic data is provided. Multi-channel sonic data is received which represents sonic energy measured in a borehole. The multi-channel data includes data from each of two or more channels. The data from two or more of the channels is combined to generate stacked sonic data. Coherent energy associated with the stacked sonic data is calculated. Unwanted signals are then attenuated based at least in part on comparing the calculated coherent energy to a predetermined threshold.

Additionally, according to some embodiments a system for processing borehole sonic data is provided. A storage system adapted and configured to receive multi-channel sonic data representing sonic energy measured in a borehole, the multi-channel data including data from each of two or more channels. A processor is adapted and configured to combine the data from two or more of the channels to generate stacked sonic data, calculate coherent energy associated with the stacked sonic data, and attenuate unwanted signals based at least in part on comparing the calculated coherent energy to a predetermined threshold.

Further features and advantages of the invention will become more readily apparent from the following detailed description when taken in conjunction with the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a wellsite system in which the present invention can be employed, according to some embodiments;

FIG. 2 illustrates a sonic logging-while-drilling tool, according to some embodiments;

FIG. 3 is a plot showing the behavior of various modified semblance criterions, according to some embodiments;

FIG. 4 is a plot showing a slowness estimation error probability distribution;

FIG. 5 shows a plot for a case where the threshold is restricted to the region around 60 μs/ft to suppress an LWD collar arrival, according to certain embodiments;

FIG. 6 is a waveform plot showing the synthetic data used for performance comparisons; and

FIGS. 7a-e are contour plots showing a comparison of the performance of various semblance modification embodiments using the synthetic data shown in FIG. 6.

### DETAILED DESCRIPTION OF THE PREFERRED EMBODIMENTS

In the following detailed description of the preferred embodiments, reference is made to accompanying drawings, which form a part hereof, and within which are shown by way of illustration specific embodiments by which the invention may be practiced. It is to be understood that other embodiments may be utilized and structural changes may be made without departing from the scope of the invention.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice. Further, like reference numbers and designations in the various drawings indicated like elements.

According to some embodiments, a given threshold on the received acoustic energy is used to suppress semblance output on weaker arrivals such as collar arrivals. This can be accomplished via a modification of the semblance criterion. One approach is based on the interpretation of the semblance as a test statistic for detecting coherent arrivals of any energy, as explained below, and modifies this to incorporate the energy threshold requirement. This leads to two new candidate modifications based on implementing the threshold in the detection problem formulation in two different ways as detailed below. According to other embodiments, intuitive and heuristic arguments are used to obtain relatively simple modifications. According to these embodiments, the coherent energy is thresholded and the minimum energy threshold is subtracted from both coherent and incoherent energy. The performance of the modified criterions is examined and various embodiments are compared on synthetic data.

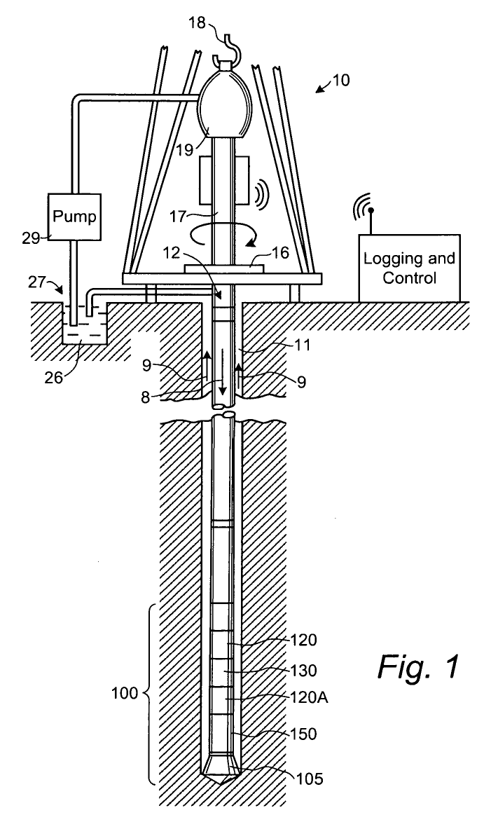

FIG. 1 illustrates a wellsite system in which the present invention can be employed. The wellsite can be onshore or offshore. In this exemplary system, a borehole 11 is formed in subsurface formations by rotary drilling in a manner that is well known. Embodiments of the invention can also use directional drilling, as will be described hereinafter.

A drill string 12 is suspended within the borehole 11 and has a bottom hole assembly 100 which includes a drill bit 195 at its lower end. The surface system includes platform and derrick assembly 10 positioned over the borehole 11, the assembly 10 including a rotary table 16, kelly 17, hook 18 and rotary swivel 19. The drill string 12 is rotated by the rotary table 16, energized by means not shown, which engages the kelly 17 at the upper end of the drill string. The drill string 12 is suspended from a hook 18, attached to a traveling block (also not shown), through the kelly 17 and a rotary swivel 19 which permits rotation of the drill string relative to the hook. As is well known, a top drive system could alternatively be used.

In the example of this embodiment, the surface system further includes drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string and the wall of the borehole, as indicated by the directional arrows 9. In this well known manner, the drilling fluid lubricates the drill bit 105 and carries formation cuttings up to the surface as it is returned to the pit 27 for recirculation.

The bottom hole assembly 100 of the illustrated embodiment a logging-while-drilling (LWD) module 120, a measuring-while-drilling (MWD) module 130, a roto-steerable system and motor 150, and drill bit 105.

The LWD module 120 is housed in a special type of drill collar, as is known in the art, and can contain one or a plurality of known types of logging tools. It will also be understood that more than one LWD and/or MWD module can be employed, e.g. as represented at 120A. (References, throughout, to a module at the position of 120 can alternatively mean a module at the position of 120A as well.) The LWD module includes capabilities for measuring, processing, and storing information, as well as for communicating with the surface equipment. In the present embodiments, the LWD module includes a sonic measuring device. Further, according to some embodiments, the various processing steps described herein are carried out in a processor located within LWD module 120.

The MWD module 130 is also housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-bit measuring device, a torque measuring device, a vibration measuring device, a shock measuring device, a stick slip measuring device, a direction measuring device, and an inclination measuring device.

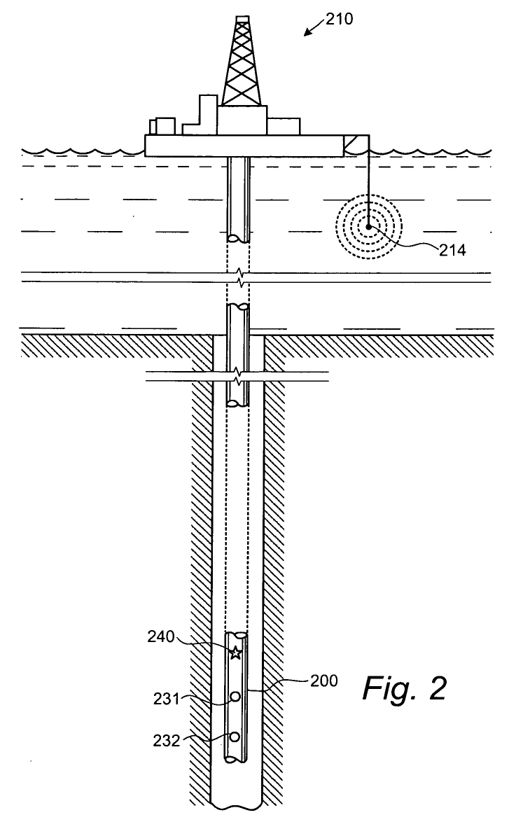

FIG. 2 illustrates a sonic logging-while-drilling tool which can be the LWD tool 120, or can be a part of an LWD tool suite 120A of the type described in U.S. Pat. No. 6,308,137, incorporated herein by reference. In a disclosed embodiment, as shown in FIG. 2, an offshore rig 210 is employed, and a sonic transmitting source or array 214 is deployed near the surface of the water. Alternatively, any other suitable type of uphole or downhole source or transmitter can be provided. For example, downhole source 240 can be used, according to some embodiments. An uphole processor controls the firing of the transmitter 214. The uphole equipment can also include acoustic receivers and a recorder for capturing reference signals near the source. The uphole equipment further includes telemetry equipment for receiving MWD signals from the downhole equipment. The telemetry equipment and the recorder are typically coupled to a processor so that recordings may be synchronized using uphole and downhole clocks. The downhole LWD module 200 includes at least acoustic receivers 231 and 232, which are coupled to a signal processor so that recordings may be made of signals detected by the receivers in synchronization with the firing of the signal source.

The classical semblance criterion as proposed in Kimball 1984, and how it is used for estimating slowness will now be reviewed. Given an array of waveforms, xₗ(t),l=1, . . . ,L, we proceed by placing windows of specified length T_{W} at time locations and moveouts given by τ and p respectively, and computing the semblance criterion given by the following for each of these windows.

$$ρ ( τ , p ) = \frac{{\int }_{τ}^{τ + {T}_{w}} {\vert {\sum }_{l = 1}^{L} {x}_{l} ( t + p {δ}_{t} ) \vert}^{2} d t}{L {\int }_{τ}^{τ + {T}_{w}} {\sum }_{l = 1}^{L} {\vert {x}_{l} ( t + p {δ}_{t} ) \vert}^{2} d t} \qquad ( 1 )$$

The moveout corresponding to the peaks of the semblance above are then declared to be the slowness of the non-dispersive components in the received data.

For discrete time sampled systems, the integrals in the above equation (1) are replaced by sums over corresponding windows:

$$ρ ( τ , p ) = \frac{{\sum }_{n}^{{N}_{w}} {\vert {\sum }_{l = 1}^{L} {D}_{p {δ}_{t} + τ} {x}_{l} ( n ) \vert}^{2}}{L {\sum }_{n}^{{N}_{w}} {\sum }_{l = 1}^{L} {\vert {D}_{p {δ}_{t} + τ} {x}_{l} ( n ) \vert}^{2}} \qquad ( 2 )$$

where D_{δ}, is a time-shift operator that shifts the input by δₜ (which need not be a multiple of the time sampling period).

This criterion has been studied and is widely used in the processing of non-dispersive arrivals as it has been successful in identifying arrivals irrespective of amplitude. For example, see E. J. Douze and S. J. Laster Statistics of semblance Geophysics, 44(12): 1999-2003, December 1979, (hereinafter “Douze 1979”), which is incorporated herein by reference.

Signal Detection Problem

It will now be shown that the semblance criterion is simply the likelihood ratio test statistic for a detection (hypothesis testing) problem. To see this, let us consider the signal detection problem for the case where we observe Y_{L×N}_{_{w}}, comprising length-N_{w} traces collected at L receivers and are trying to detecting if a common (but unknown) signal s^{t} (transposed to indicate it is a row vector) is present in all receivers.

In other words we have the following hypothesis testing problem:

H₀: Y=N

vs. H₁:Y=1s^{t}+N

where l is a column vector of all l's, and is used to indicate that the same signal trace s^{t} is present in all receivers under hypothesis H1. N represents the noise which is assumed to follow the white Gaussian distribution with unknown variance σ².

This hypothesis testing problem can be solved by computing the Generalized Likelihood Ratio Test (GLRT) statistic and comparing to a threshold. Harry L. Van Trees Detection, Estimation and Modulation Theory, Part I. Wiley, N.Y., 1968 (hereinafter “Van Trees 1968”) incorporated herein by reference. The GLRT is obtained by computing the likelihood function under each hypothesis and taking the ratio of its maximized value for each hypothesis. Note that the likelihood function is obtained from the probability model for the observed data; it is simply the probability density function evaluated at the observed value expressed as a function of the parameters of the probability model, i.e., when we have a observable X with a probability density function f_{Xl0} from a model parameterized by θ, we can write the likelihood function for a given observed value x as L(θ|x)=f_{Xlθ}(x)). Rather than the ratio of likelihoods, we can equivalently consider the difference of the log of the likelihood functions and get

$${t}_{GLRT} {=}^{def} {max}_{{θ}_{1}} LL ( {θ}_{1} \vert Y , {H}_{1} ) - {max}_{{θ}_{0}} LL ( {θ}_{0} \vert Y , {H}_{0} ) \qquad ( 3 )$$

where LL is the log-likelihood function.

According to some embodiments, we compute the log likelihood function under H₁ using the assumption of white Gaussian noise like so

$$LL ( {σ}^{2} , s \vert Y ; {H}_{1} ) = K - \frac{{N}_{w} L}{2} log {σ}^{2} - \frac{1}{2 {σ}^{2}} {‖ Y - \underline{1} {\underline{s}}^{t} ‖}_{F}^{2} \qquad ( 4 )$$

where ∥·∥_{F}² refers to the Frobenius norm of the argument and

$$K = - \frac{{N}_{w} L}{2} log ( 2 π )$$

is a constant. The quantity inside the Frobenius norm can be shown to consist of

∥Y−1s^{t}∥_{F}²=∥P₁^{⊥}Y∥_{F}²+∥P₁Y−1s^{t}∥_{F}² (5)

where

$${P}_{\underline{1}} = \frac{1}{L} \underline{1} ,$$

1^{r} is the projection onto the subspace of 1while P₁^{⊥} is the projection operator on the orthogonal complement of that space.

The log likelihood in equation (4) can be maximized with respect to the unknown signal s by minimizing the Frobenius norm in equation (5). It is easily seen that this is obtained by setting

$$\hat{s} = \frac{1}{L} {\underline{1}}^{I} \cdot Y$$

which makes the second term in (5) equal to zero. Finally we maximize the likelihood with respect to σ² by setting

$${\hat{σ}}^{2} = \frac{{‖ {P}_{\underline{1}}^{⊥} Y ‖}_{F}^{2}}{{N}_{w} L}$$

by using the fact that −nlog x−b/x is maximized when x=b/n.

Substituting these estimates back into the expression for the log-likelihood function in equation (4), we get

$${max}_{{θ}_{1}} LL ( {θ}_{1} \vert Y , {H}_{1} ) = K - \frac{{N}_{w} L}{2} log ( \frac{{‖ {P}_{\underline{1}}^{⊥} Y ‖}_{F}^{2}}{{N}_{w} L} ) - \frac{{N}_{w} L}{2} \qquad ( 6 )$$

where K is the same constant as in equation (4).

Carrying out a similar development for the log likelihood under H₀, we obtain

$${max}_{{θ}_{0}} LL ( {θ}_{0} \vert Y , {H}_{0} ) = K - \frac{{N}_{w} L}{2} log ( \frac{{‖ Y ‖}_{F}^{2}}{{N}_{w} L} ) - \frac{{N}_{w} L}{2} \qquad ( 7 )$$

with K being the same constant as above.

Therefore we can now obtain the GLRT statistic by taking the difference of (6) and (7) and canceling the common terms:

$${t}_{GLRT} = \frac{{N}_{w} L}{2} log \frac{{‖ Y ‖}_{F}^{2}}{{‖ {P}_{\underline{1}}^{⊥} Y ‖}_{F}^{2}} .$$

We note as before that

∥P₁^{⊥}Y∥_{F}²=∥Y∥_{F}²−∥P₁Y∥_{F}²

and therefore we have

$$\begin{matrix}{t}_{GLRT} = \frac{{N}_{w} L}{2} log \frac{1}{1 - ρ} \\ \text{where} & ( 8 ) \\ ρ = \frac{{‖ {P}_{\underline{1}} Y ‖}_{F}^{2}}{{‖ Y ‖}_{F}^{2}} = \frac{{‖ {\underline{1}}^{t} \cdot Y ‖}_{F}^{2}}{L {‖ Y ‖}_{F}^{2}} = \frac{{Σ}_{n} {\vert {Σ}_{l} {Y}_{l n} \vert}^{2}}{L {Σ}_{n} {Σ}_{l} {\vert {Y}_{l n} \vert}^{2}} & ( 9 )\end{matrix}$$

We observe that the last quantity ρ has exactly the same form as the semblance of equation (2) used in non-dispersive processing. Since the GLRT is a monotonic function of the semblance ρ, we hold the latter to be equivalent to the former for the purpose of detecting a signal present in all the sensors.

Therefore we can interpret our slowness processing methodology as running a detector for each of a number of time-window locations and moveouts and estimating the slowness of propagating non-dispersive components as those values of the moveout where the detector output shows a local peak.

We note that the semblance criterion is invariant to any scaling of the data and so is effective at detecting weak arrivals such as the compressional even with widely varying amplitudes. Hence it is widely used in the commercial processing.

Proposals for Modification of Semblance

We now turn to addressing the issue (particularly for LWD) resulting from the same scale invariance, namely that in some cases, weak undesired arrivals such as tool or casing (even after mitigation steps in hardware and/or pre-processing) could register as high semblance events thereby masking or confusing the downhole processing of the true arrivals.

Using the insight obtained from the previous section, we can address this issue by requiring a minimum energy threshold for the signal to be detected. We consider two different ways of incorporating this requirement in the signal detection problem and derive suitable modifications in each case to the detection test statistic and therefore the semblance in the following two subsections.

Detection of Signal Above Threshold

According to some embodiments, the detection problem is set up as a hypothesis testing problem as before but with the additional requirement that the signal present under H₁ meets some specified threshold on its energy (or amplitude):

H₀:Y=N

vs. H₁: Y=1s^{t}+N,∥s^{t}∥²≧ε²

where now we have imposed a threshold ε² on the energy of the unknown signal.

The maximized log likelihood under H₀ is identical to that of the previous section. We therefore look at the quantity under H₁. As before we compute

$$LL ( {θ}_{1} \vert Y , {H}_{1} ) = K - \frac{{N}_{w} L}{2} log {σ}^{2} - \frac{1}{2 {σ}^{2}} \{ {‖ {P}_{\underline{1}}^{⊥} Y ‖}_{F}^{2} + {‖ {P}_{\underline{1}} Y - \underline{1} {\underline{s}}^{t} ‖}_{F}^{2} \} . \qquad ( 10 )$$

We first maximize this with respect to s^{t} subject to the following constraint on the signal norm

∥s^{t}∥≧ε (11)

Focusing on the term containing s^{t}, we seek to minimize it in order to maximize the log likelihood and find that the minimizing argument under the constraint is given by

$${\hat{\underline{s}}}^{t} = {\hat{s}}_{1} \frac{{\underline{1}}^{t} \cdot Y}{‖ {\underline{1}}^{t} \cdot Y ‖}$$

with the signal amplitude estimate given by

$${\hat{s}}_{1} = max ( ɛ , \frac{‖ {\underline{1}}^{t} \cdot Y ‖}{L} ) . \qquad ( 12 )$$

It can be shown that the quadratic terms in braces in equation (1) equal

$${‖ Y ‖}_{F}^{2} - \frac{{‖ {\underline{1}}^{t} \cdot Y ‖}^{2}}{L} [ 1 - {\{ 1 - \frac{max ( L ε , ‖ {\underline{1}}^{t} Y ‖ )}{‖ {\underline{1}}^{t} Y ‖} \}}^{2} ]$$

The second term (times L) further simplifies after some algebra to

$$max ( L ε , ‖ {\underline{1}}^{t} \cdot Y ‖ ) ( 2 ‖ {\underline{1}}^{t} \cdot Y ‖ - max ( L ε , ‖ {\underline{1}}^{t} \cdot Y ‖ ) ) = {‖ {\underline{1}}^{t} \cdot Y ‖}^{2} - {max ( 0 , L ε - ‖ {\underline{1}}^{t} \cdot Y ‖ )}^{2} {=}^{def} v \qquad ( 13 )$$

Repeating the same steps as in the previous section we obtain the GLRT statistic for this problem as

$${t}_{GLRT} = \frac{{N}_{w} L}{2} log \frac{1}{1 - \overline{ρ}} \qquad ( 14 )$$

where we have defined an analogous (modified) semblance criterion

$$\overline{ρ} = \frac{v}{L {‖ Y ‖}_{F}^{2}} \qquad ( 15 )$$

with v defined in (13).

Rejection of Signal Below Threshold

According to some embodiments a more general scenario is used where a threshold under H₀ is also invoked. In other words, we expect that a signal could be present below a threshold but interpret it as a spurious arrival rather than the desired signal. Of course we need to also have a threshold to declare signal presence, and the latter threshold must be greater than the former.

In other words, we consider the detection problem as before but with the following modifications:

H₀:Y=1s^{t}+N,∥s^{t}∥²≦ε₀²

vs. H₁:Y=1s^{t}+N,∥s^{t}∥²≧ε₁²

where we now consider the signal energy to obey thresholds ε₀ and ε₁ under H₀ and H₁ respectively with ε₁≧ε₀.

The maximization of the log likelihood under H₁ is exactly the same as the previous section with ε₁ replacing ε in the corresponding expressions.

The maximization under H₀ is now also similar to that for H₁ but with the difference that the estimate for the signal amplitude is given by

$${\hat{s}}_{0} = min ( {ε}_{0} , \frac{‖ {\underline{1}}^{t} \cdot Y ‖}{L} )$$

instead of the max function of equation (12).

Working through the remaining steps we find that we can then express the GLRT statistic as

$${t}_{GLRT} = \frac{{N}_{w} L}{2} log \frac{L {‖ Y ‖}_{F}^{2} - min ( L {ε}_{0} , ‖ {\underline{1}}^{t} \cdot Y ‖ ) ( 2 ‖ {\underline{1}}^{t} \cdot Y ‖ - min ( L {ε}_{0} , ‖ {\underline{1}}^{t} \cdot Y ‖ ) )}{L {‖ Y ‖}_{F}^{2} - max ( L {ε}_{1} , ‖ {\underline{1}}^{t} \cdot Y ‖ ) ( 2 ‖ {\underline{1}}^{t} \cdot Y ‖ - max ( L {ε}_{1} , ‖ {\underline{1}}^{t} \cdot Y ‖ ) )} \qquad ( 16 )$$

This can again be put into a semblance-like form (with some work) as before

$$\begin{matrix}{t}_{GLRT} = \frac{{N}_{w} L}{2} log \frac{1}{1 - {ρ}^{=}} \\ \text{where} & ( 17 ) \\ {ρ}^{=} = \frac{{v}_{1} - {v}_{0}}{L {‖ Y ‖}_{F}^{2} - {v}_{0}} & \end{matrix}$$

with

ν₁ def ∥1^{t}·Y∥²−max(0,Le₁−∥1^{t}·Y∥)²

ν₀ def ∥1^{t}·Y∥²−max(0,∥1^{t}·Y∥−Le₀)² (18)

Behavior

We now take a look at the behavior of the new semblance criterions according to the embodiments described above. We first note that the modified criterion of equation (15) equals the standard semblance quantity when the signal estimate exceeds the threshold

$$\frac{‖ {\underline{1}}^{t} \cdot Y ‖}{L} > ɛ$$

and we have absolutely no difference from the standard output. However when the signal norm is below the threshold, the semblance drops rapidly towards zero equaling it at half the threshold value. Below that it turns negative, but that can be ignored as it implies that the presence of signal above the desired threshold is extremely unlikely and in practice we saturate it at zero.

Simple Thresholded Semblance

The above property of a likelihood ratio detector motivates a much simpler modification of the semblance. According to some embodiments, we simply threshold the coherent energy at the specified energy threshold and compute the corresponding semblance.

$${ρ}_{τ} = \frac{{( {T}_{L ε} ( ‖ \underline{1} \cdot Y ‖ ) )}^{2}}{L {‖ Y ‖}_{F}^{2}} \qquad ( 19 )$$

where T_{τ} is the thresholding function:

$${T}_{τ} ( t ) = \{ \begin{matrix}t & if t \geq τ \\ 0 & otherwise\end{matrix}$$

In other words, we consider the coherent energy only if it exceeds the stated threshold while computing the semblance and call this modification the thresholded semblance. Clearly this exactly equals the original semblance when the coherent energy exceeds the threshold.

Subtracted Semblance

Another modification is inspired by the form of equation (17). According to these embodiments, we subtract the energy threshold from both the coherent and total energy to correspond to rejection of any signals present below the threshold.

Thus we get the following form:

$${ρ}_{b} = \frac{max ( 0 , {‖ \underline{1} \cdot Y ‖}^{2} - {( L ε )}^{2} )}{max ( δ , L {‖ Y ‖}_{F}^{2} - {( L ε )}^{2} )} \qquad ( 20 )$$

where we have thresholded the quantities to keep everything positive and have set a small positive minimum δ to keep the semblance stable (this is usually used in a standard semblance as well).

Alternatively we could modify the numerator of the semblance quantity by attenuating it when it falls below a given threshold.

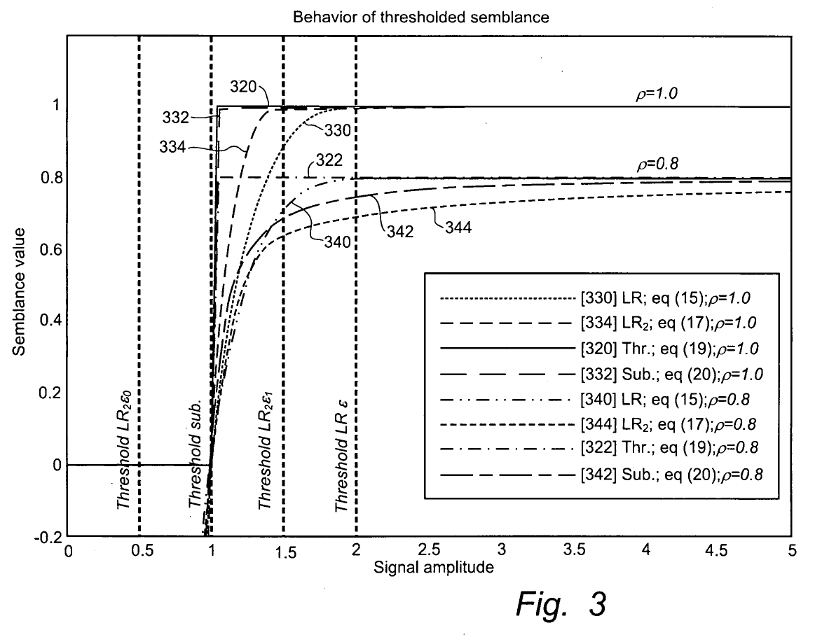

The modified semblance of equations (17) and (18) is a general expression, reducing to the single threshold case of (15) when ε₀=0 and to the original semblance when ε₁=0. However we note that while ν₁ reduces to ∥1·Y∥² when the signal estimate as shown above exceeds the threshold ε₁, the same is not true for ν₀. Therefore the modified semblance of equation (17) is never exactly equal to the original unmodified semblance but is smaller or attenuated. This attenuation bias however becomes small as the signal amplitude rises well above the threshold, the extent of the bias being dependent on the value of the original semblance. The modified semblance of equation (20) exhibits similar behavior. This point is illustrated in FIG. 3 as described below.

FIG. 3 is a plot showing the behavior of various modified semblance criterions, according to some embodiments. The behavior is shown for two cases, with the signal and total energy varied so as keep the original semblance respectively ρ=1.0 and ρ=0.8. The thresholds shown in FIG. 3 are chosen so that we get a semblance value of zero at the same value of signal amplitude. The modified semblance outputs of equations (15), (17), (19) and (20) are shown as a function of signal amplitude for two values of the original semblance (1.0 and 0.8). In particular, curve 330 is the output of equation (15) for original semblance of 1.0. Curve 334 is the output of equation (17) for the original semblance of 1.0. Curve 320 is the output of equation (19) for the original semblance of 1.0. Curve 332 is the output of equation (20) for the original semblance of 1.0. Curve 340 is the output of equation (15) for the original semblance of 0.8. Curve 344 is the output of equation (17) for the original semblance of 0.8. Curve 322 is the output of equation (19) for the original semblance of 0.8. Curve 342 is the output of equation (20) for the original semblance of 0.8. As mentioned, the thresholds for each case are chosen so as to align the zero cutoff for each modified criterion. In particular, the threshold for the embodiments of equation (15) are ε=2; the thresholds for the embodiments of equation (17) are ε₀=0.5 and ε₁=1.5; the threshold for the embodiments of equations (19) and (20) are 1. It can be observed that while the “LR” (equation (15), curves 330 and 340) and “Thr” (equation (19), curves 320 and 322) criterion give back the original semblance above its threshold, the other two (equation (17), curves 334 and 344; and equation (20), curves 332 and 342) show a bias especially when the original semblance is below 1. However this bias quickly becomes small as signal amplitude increases and for values well above the threshold, the difference from the original is small.

The signal detection performance has been examined based on Monte Carlo simulations using 10000 trials using signal+noise and noise only data to estimate the probability of detection (PD) for a given probability of false alarm (PFA) of 0.01. This was repeated for a number of signal levels keeping the noise level fixed. It has been found that embodiments described with respect to equations (15), (17), (19) and (20) are all effective. In particular, while the original, unthreholded semblance detects signals below the desired level, the modified criterions successfully discriminate against such cases.

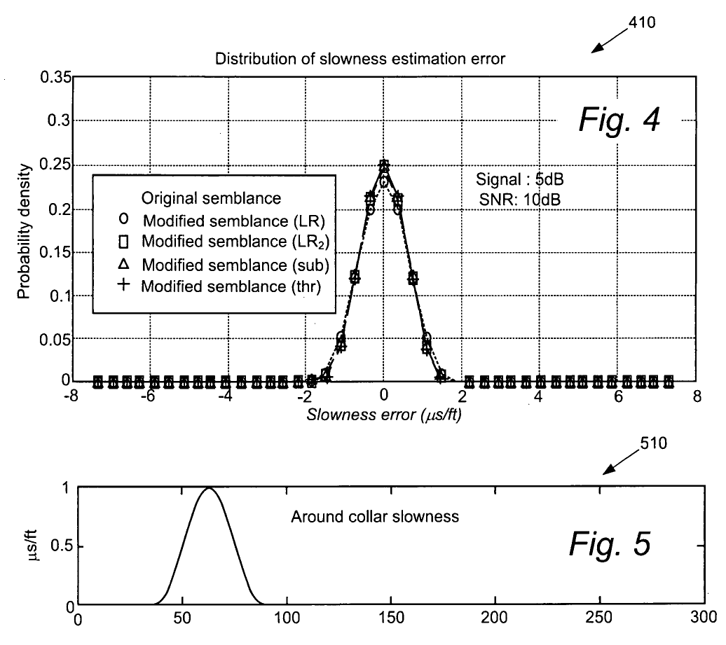

The slowness estimation accuracy has been evaluated using the modified criterions and compare to that of the original unthresholded semblance. We again ran Monte Carlo simulations to tabulate the deviation of the semblance peak slowness from the true value. FIG. 4 is a plot showing the slowness estimation error probability distribution. Plot 410 shows the slowness estimation error probability distribution at an SNR of 5 dB for the original and each of the modified criterions. It can be observed from FIG. 4 that the error distribution is virtually identical for all cases and the slowness measurement is not compromised by the use of the modifications to suppress the weak signals.

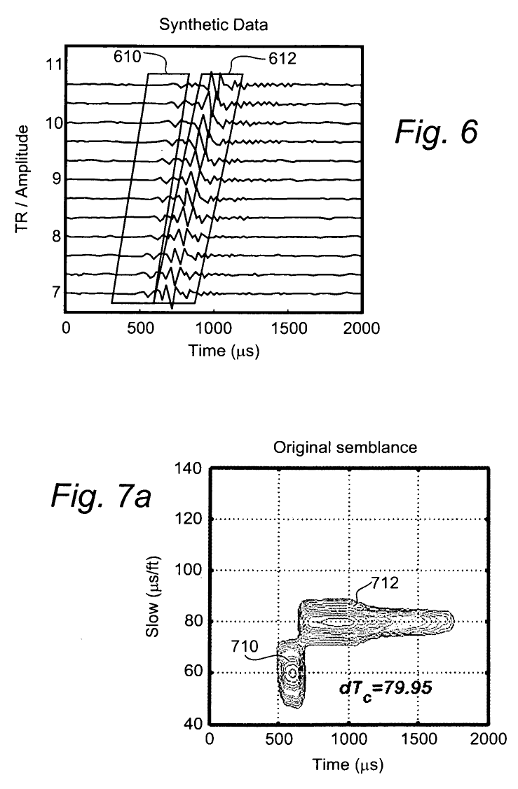

According to some embodiments, the impact of the threshold can be further minimized by customizing it to the slowness-time region where we expect the unwanted arrivals. For example, if the unwanted signal is a weak collar arrival, we may know the approximate slowness of that and can customize the threshold around it. The signal energy threshold is set as a function of slowness so as to apply in the vicinity of the expected collar slowness. A similar customization could be done around the expected time of arrival of the signal. FIG. 5 shows a plot 510 for a case where the threshold is restricted to the region around 60 μs/ft to suppress an LWD collar arrival. According to other embodiments, if we can predict the time of arrival as well, we could similarly restrict the threshold in the time domain too.

Results Comparison

We now compare the performance of the modified semblance criterions with the original one starting with a synthetic example. A synthetic waveform was constructed containing two components with moveouts of 60 μs/ft and 80 μs/ft respectively. The first component is taken as a weak undesired arrival (amplitude=1) such as the collar while the second is the desired signal such as the compressional, (amplitude=5). Noise was added corresponding to an SNR of 20 dB.

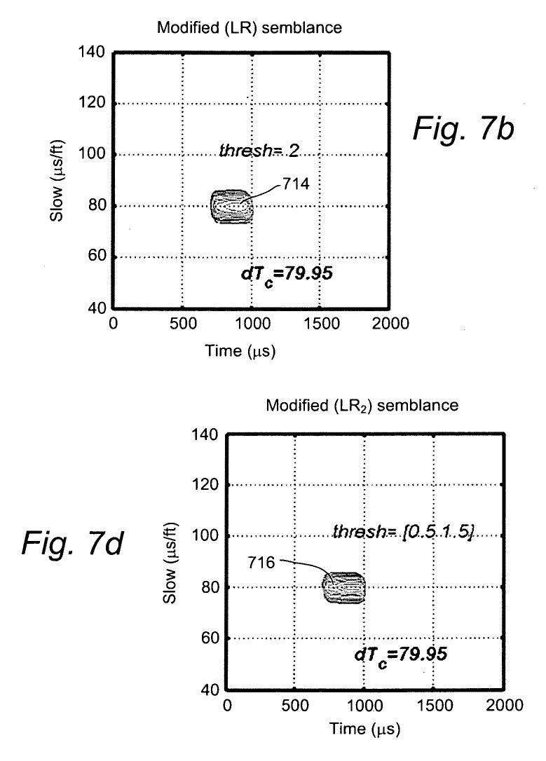

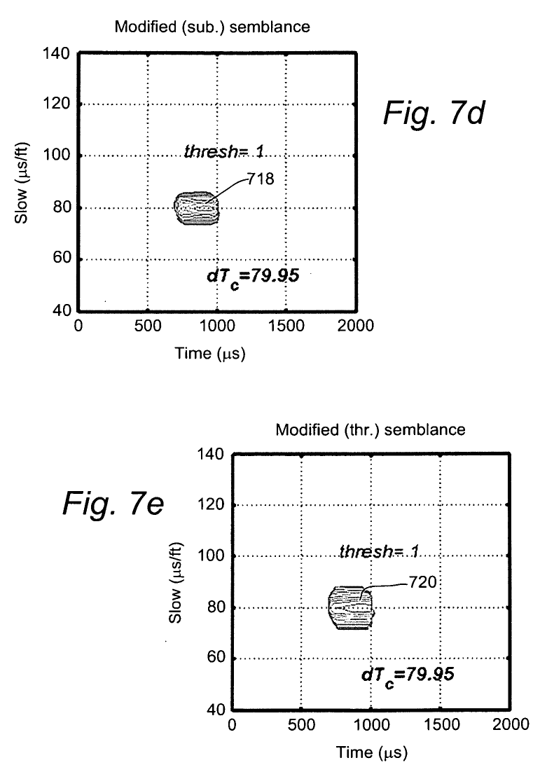

FIG. 6 is a waveform plot showing the synthetic data used for performance comparisons. The synthetic data illustrated in FIG. 6 shows two arrivals: a “tool” arrival 610 with an amplitude of 1, and a “compressional” arrival 612 with an amplitude of 5. FIG. 7a-e are contour plots showing a comparison of the performance of various semblance modification embodiments using the synthetic data shown in FIG. 6. FIG. 7a shows the contour plot of the original semblance on the STC plane. We see the presence of two arrivals, namely arrival 710 which corresponds to the tool arrival 610 from FIG. 6, and arrival 712 which corresponds to the compressional arrival 612 from FIG. 6. FIG. 7b shows a contour plot of the first modified criterion, according to equation (15) with a threshold of 2. In FIG. 7b, arrival 714 corresponds to the compressional arrival 612. It can also be seen form FIG. 7b that the first undesired arrival, the tool arrival 610 from FIG. 6, is effectively suppressed. Interestingly we see that the long tail of the STC contours of arrival 714 also gets truncated as the threshold operates to remove the contribution from the weak cauda of the second component. FIG. 7c shows a contour plot of the second modified criterion, according to equation (17), with thresholds of 0.5 and 1.5, and arrival 716 which corresponds to the compressional arrival 612 of FIG. 6. FIG. 7d show a contour plot of the modified semblance obtained by subtracting the threshold from the coherent and total energy, according to equation (19). Arrival 718 corresponds to the compressional arrival 612 of FIG. 6. The contours are sharper and show lower semblance consistent with the behavior seen in FIG. 3, curves 332 and 342. Finally FIG. 7e shows a contour plot for the thresholded semblance, which is simply a masked portion of the original semblance contour but retaining the peaks of interest, according to equation (20). Arrival 720 corresponds to the compressional arrival 612 of FIG. 6. Note that in all the cases shown in FIGS. 7b-e, the estimated slowness is very close to the true value of 80.

The modified semblance criterion have also been evaluated on LWD field data in a location where the formation is fast and the compressional arrival comes close to the tool arrival. It was observed that the collar arrival, which was apparent after the conventional semblance processing, was effectively removed using each of the modified semblance criterions with no impact on the main arrival.

Whereas many alterations and modifications of the present invention will no doubt become apparent to a person of ordinary skill in the art after having read the foregoing description, it is to be understood that the particular embodiments shown and described by way of illustration are in no way intended to be considered limiting. Further, the invention has been described with reference to particular preferred embodiments, but variations within the spirit and scope of the invention will occur to those skilled in the art. It is noted that the foregoing examples have been provided merely for the purpose of explanation and are in no way to be construed as limiting of the present invention. While the present invention has been described with reference to exemplary embodiments, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1 A method of processing borehole sonic data comprising:
receiving multi-channel sonic data representing sonic energy measured in a borehole, the multi-channel data including data from each of two or more channels;
combining the data from two or more of the channels to generate stacked sonic data;
calculating coherent energy associated with the stacked sonic data; and
attenuating unwanted signals based at least in part on the calculated coherent energy.

2. A method according to claim 1 wherein the attenuation of unwanted signals is based at least in part on comparing the calculated coherent energy to a predetermined threshold.

3. A method according to claim 2 wherein the unwanted signals are removed in cases where the calculated coherent energy is less than the predetermined threshold.

4. A method according to claim 1 further comprising calculating semblance values based on the coherent energy wherein the semblance values are attenuated in cases where the calculated coherent energy is less than the predetermined threshold.

5. A method according to claim 1 further comprising:
calculating a probability function of a criterion to decide if the signal should be attenuated or not; and
calculating semblance values based on the calculation of the probability function and the calculated coherent energy, wherein the semblance values are attenuated based on the calculated probability function.

6. A method according to claim 5 wherein the probability function includes a likelihood function or a log likelihood function.

7. A method according to claim 5 wherein the probability function corresponds to detecting signals above a predetermined threshold energy.

8. A method according to claim 5 wherein the probability function corresponds to rejecting signals below a predetermined threshold energy.

9. A method according to claim 2 wherein the predetermined threshold is a fixed value.

10. A method according to claim 2 wherein the predetermined threshold is a function of a parameter associated with the sonic data.

11. A method according to claim 10 wherein the predetermined threshold is a function of slowness and/or time so as to apply to an expected type of signal.

12. A method according to claim 11 wherein the signal type is an unwanted tool-propagated signal or casing arrival.

13. A method according to claim 11 wherein the signal type is a compressional signal arrival of interest.

14. A method according to claim 1 wherein the multi-channel sonic data is measured during a drilling operation using a plurality of sonic receivers mounted on a drill collar body.

15. A method according to claim 14 wherein the method is carried out using a processing system housed within the drill collar body.

16. A method according to claim 1 wherein the multi-channel sonic data is measured using a wireline tool having at least one sonic source and a plurality of sonic receivers mounted thereon.

17. A system for processing borehole sonic data comprising:
a storage system adapted and configured to receive multi-channel sonic data representing sonic energy measured in a borehole, the multi-channel data including data from each of two or more channels; and
a processor adapted and configured to combine the data from two or more of the channels to generate stacked sonic data, calculate coherent energy associated with the stacked sonic data, and attenuate unwanted signals based at least in part on comparing the calculated coherent energy to a predetermined threshold.

18. A system according to claim 17 further comprising a tool body suitable for downhole deployment, wherein the storage system and processor are housed within the tool body.

19. A system according to claim 18 further comprising a plurality of downhole sonic receivers mounted on a drill collar adapted to measure the multi-channel sonic energy, wherein the tool body is positioned on the drill collar and the storage system records the sonic measurements from the sonic receivers.

20. A system according to claim 17 wherein the multi-channel sonic data is measured using a wireline tool having at least one sonic source and a plurality of sonic receivers mounted thereon, and wherein the processing system is located on the surface.

21. A system according to claim 17 wherein the processor is further adapted and configured to calculate semblance values based on the calculated coherent energy, the semblance values being attenuated in cases where the calculated coherent energy is less than the predetermined threshold.

22. A system according to claim 17 wherein the processor is further adapted and configured to calculate a probability function of a criterion to decide if the signal should be attenuated or not, and to calculate semblance values based on the calculation of the probability function and the calculated coherent energy, and wherein the semblance values are attenuated based on the calculated probability function.

23. A system according to claim 22 wherein the probability function includes a likelihood function or a log likelihood function.

24. A system according to claim 22 wherein the probability function corresponds to detecting signals above a predetermined threshold energy.

25. A system according to claim 22 wherein the probability function corresponds to rejecting signals below a predetermined threshold energy.

26. A system according to claim 17 wherein the predetermined threshold is a function of a parameter associated with the sonic data.

27. A system according to claim 26 wherein the predetermined threshold is a function of slowness and/or time so as to apply to an expected type of unwanted signal.
